(19) United States
(12) Patent Application Publication
(10) Pub. No.: US 2025/0368812 A1
(43) Pub. Date: Dec. 4, 2025

(54) POLYMER RECYCLATE BLENDS AND PRODUCTS

(71) Applicant: Equistar Chemicals, LP, Houston, TX (US)

(72) Inventors: Harilaos Mavridis, Lebanon, OH (US); Lindsay E. Corcoran, Liberty Township, OH (US); Sameer D. Mehta, Mason, OH (US)

(73) Assignee: Equistar Chemicals, LP, Houston, TX (US)

(21) Appl. No.: 19/221,011

(22) Filed: May 28, 2025

Related U.S. Application Data
(60) Provisional application No. 63/653,553, filed on May 30, 2024.

(51) Int. Cl. C08L 23/26; B29B 7/20; B29B 7/82; B29K 23/00; B29K 105/26

(52) U.S. Cl. CPC C08L 23/26; B29B 7/20; B29B 7/82; B29K 2023/0625; B29K 2023/065; B29K 2105/26; B29K 2995/0012; B29K 2995/0046; B29K 2995/0063; B29K 2995/0089; C08L 2023/42; C08L 2205/025; C08L 2207/062; C08L 2207/20

(57) ABSTRACT

A composition and method for producing high-density polyethylene (HDPE) pails with elevated post-consumer recycled (PCR) content. HDPE recyclate is modified to form a modified HDPE recyclate. A blend comprising a majority of the modified HDPE recyclate and a linear low-density polyethylene (LLDPE) is provided as a substitute for virgin HDPE currently used in production of injection molded pails. By employing thermal visbreaking technology alongside specialized recipe formulation, the resulting composition matches or surpasses the processability and key performance attributes of conventional virgin HDPE pails.

### PRIOR RELATED APPLICATION

This application claims the benefit of priority to U.S. Provisional Application No. 63/653,553, filed on May 30, 2024, which is incorporated here by reference in its entirety.

### FIELD OF THE INVENTION

The present disclosure relates to blends comprising a polymer recyclate, more particularly, to blends of a high-density polyethylene (HDPE) recyclate and a linear low density polyethylene (LLDPE), wherein such blends are suitable for injection molding applications such as production of HDPE pails.

### BACKGROUND OF THE INVENTION

HDPE pails are widely used in various industries for their durability, chemical resistance, and versatility. However, there is an increasing demand for sustainable manufacturing practices, including the use of post-consumer recycled (PCR) materials to reduce environmental impact of plastics.

Traditionally, HDPE pails have been manufactured using virgin HDPE materials to achieve the desired mechanical properties, such as impact resistance and environmental stress crack resistance (ESCR). The use of PCR HDPE in such applications has been limited due to the lack of suitable PCR that can meet the stringent performance requirements of HDPE pails. Specifically, HDPE pails require a balance of stiffness and toughness to withstand the rigors of use, including handling, stacking, and transportation.

Current PCR HDPE materials available in the market, such as fractional melt index HDPE recyclate may find use in blow molding applications but do not provide the necessary performance characteristics injection molding applications such as HDPE pails. Blending these materials into HDPE pail compositions often results in compromised processability and end-use properties, and the content of PCR material that can be incorporated is typically low or modest at best.

There is, therefore, a need for a HDPE composition that incorporates a high content of PCR material while maintaining or improving upon the processability and end-use properties of virgin HDPE pails. Such a composition would not only contribute to environmental sustainability by reducing reliance on virgin materials and diverting waste from landfills but also provide manufacturers with a competitive advantage in markets where eco-friendly products are increasingly valued.

### SUMMARY OF THE INVENTION

The disclosure relates to a composition comprising a blend of a high proportion of a modified HDPE recyclate with a linear low density polyethylene (LLDPE). The composition is suitable for use in injection molding applications such as the production of HDPE pails or other containers useful in residential, commercial, and industrial applications. Equivalent or better processability and/or physical performance than virgin HDPE is achieved with blends of a modified HDPE recyclate and LLDPE.

In general, the present disclosure relates to a composition suitable for injection molding applications. The composition comprises from 50 wt. % to 95 wt. % of a modified high density polyethylene (HDPE) recyclate and from 5 wt. % to 50 wt. % of a linear low density polyethylene (LLDPE), wherein weight percentages are based on the total weight of the modified HDPE recyclate and the LLDPE. In some embodiments, the modified HDPE recyclate is a product of thermally visbreaking an HDPE recyclate.

A method for producing a composition useful injection molding using a high density polyethylene (HDPE) recyclate, the method comprising: a) providing a HDPE recyclate having a MI (2.16 kg, 190° C.) in the range of from 0.1 dg/min. to 1.0 dg/min.; b) subjecting the HDPE recyclate to visbreaking conditions to produce a modified HDPE recyclate having a MI (2.16 kg, 190° C.) in the range of from 2.0 dg/min. to 20 dg/min.; and c) blending the modified HDPE recyclate with a linear low density polyethylene (LLDPE) to produce the composition. In some embodiments, visbreaking conditions comprise thermal visbreaking or thermal visbreaking and devolatilization.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other blends and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE FIGURES

The claimed subject matter may be understood by reference to the following description taken in conjunction with the accompanying drawings, in which like reference numerals identify like elements, and in which:

FIG. 1 is simplified flow diagram of a process to obtain a blend of a visbroken HDPE recyclate and a virgin LLDPE using two extruders according to embodiments of the invention;

FIG. 2 is simplified flow diagram of a process to obtain a blend of a visbroken HDPE recyclate and a virgin LLDPE using three extruders according to embodiments of the invention;

FIG. 3 is an overlaid graph of complex viscosity vs. frequency comparing a blend of visbroken HDPE and Ziegler-Natta LLDPE, a blend of visbroken HDPE and metallocene LLDPE, and a benchmark virgin HDPE according to embodiments of the invention;

FIG. 4 is an overlaid graph of tan delta vs. G* comparing a blend of visbroken HDPE and Ziegler-Natta LLDPE, a blend of visbroken HDPE and metallocene LLDPE, and a benchmark virgin HDPE according to embodiments of the invention;

FIG. 5 is a graph comparing notched izod performance of blends of visbroken HDPE with LLDPE to benchmark virgin HDPE polymers according to embodiments of the invention;

FIG. 6 is a graph comparing notched constant tensile load of blends of visbroken HDPE with LLDPE to benchmark virgin HDPE polymers according to embodiments of the invention;

FIG. 7 is a graph comparing flexmod 1% secant modulus of blends of visbroken HDPE with LLDPE to benchmark virgin HDPE polymers according to embodiments of the invention;

FIG. 8 is a graph comparing container sidewall stiffness 1% secant modulus of blends of visbroken HDPE with LLDPE to benchmark virgin HDPE polymers according to embodiments of the invention; and

FIG. 9 is a graph comparing container drop performance of blends of visbroken HDPE with LLDPE to benchmark virgin HDPE polymers according to embodiments of the invention.

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

As used herein, “antioxidant agents” means compounds that inhibit oxidation, a chemical reaction that can produce free radicals and chain reactions.

As used herein, “compounding conditions” means temperature, pressure, and shear force conditions implemented in an extruder to provide intimate mixing of two or more polymers and optionally additives to produce a substantially homogeneous polymer product.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used herein, “devolatilization conditions” mean subjecting a polymer melt in an extruder to injection and withdrawal of a scavenging gas, addition of heat, physical mixing, pressure reduction by venting or applying vacuum, or a combination thereof. Devolatilization conditions implemented in an extruder are sufficient to reduce the VOC of a polymer fed to the extruder by a predetermined percentage and/or to a predetermined VOC target for polymer exiting the extruder. Devolatilization conditions are directed to reduction of VOC in a polyolefin by a portion of an extruder having an intensive mixing arrangement and devolatilization sections to enable removal of VOC at high temperatures. Devolatilization conditions can be further enhanced by injection of a gas into the extruder, distribution of the gas in the polymer melt to scavenge VOC components, and extraction of the gas and scavenged VOC components by venting or vacuum.

As used herein, “extruder,” as used herein within the context of the “first extruder,” second extruder,” and “third extruder,” in some embodiments, means separate extrusion apparatuses, and in other embodiments, means separate sections within a single extrusion apparatus. In some embodiments, the first extruder and the second extruder are separate machines. In some embodiments, the first extruder and the second extruder are separate sections in a single machine. In some embodiments, the second extruder and the third extruder are separate machines. In some embodiments, the second extruder and the third extruder are separate sections in a single machine. In some embodiments, the first extruder, the second extruder, and the third extruder are separate machines. In some embodiments, the first extruder, the second extruder, and the third extruder are separate sections in a single machine.

As used herein, “HDPE recyclate” means post-consumer recycled HDPE and/or post-industrial recycled HDPE. Polyolefin recyclate is derived from an end product comprising virgin HDPE that has completed its life cycle as a consumer item and would otherwise be disposed of as waste (e.g., a polyethylene water bottle) or from plastic scrap that is generated as waste from an industrial process. Post-consumer polyolefins include polyolefins that have been collected in commercial and residential recycling programs. Such waste is typically separated through one or more separation steps to recover two main polyolefinic fractions, namely polyethylene recyclate and polypropylene recyclate. Polyethylene recyclate can be further separated to recover a portion having HDPE as the primary constituent.

As used herein, “HDPE” means ethylene homopolymers and ethylene copolymers produced in a gas phase and/or slurry phase polymerization and having a density in the range of 0.940 g/cm³ to 0.970 g/cm³.

As used herein, “LLDPE” means ethylene copolymers produced in a gas phase and/or slurry phase polymerization and having a density in the range of 0.910 g/cm³ to 0.940 g/cm³.

As used herein, “melting conditions” means temperature, pressure, and shear force conditions, either alone or in combination with one another, that are required to produce a polymer melt from a feed of polymer pellets or powder.

As used herein, “modified HDPE recyclate” means the product obtained by subjecting an HDPE recyclate to visbreaking conditions or to visbreaking conditions followed by devolatilization conditions, as described herein.

As used herein, “virgin” polymers are pre-consumer polymers such as polyolefins. Pre-consumer polyolefins are polyolefin products obtained directly or indirectly from petrochemicals fed to a polymerization apparatus. Pre-consumer polyolefins can be subjected to post polymerization processes such as, but not limited to, extrusion, pelletization, visbreaking, and/or other processing completed before the product reaches the end-use consumer. In some embodiments, virgin HDPE comprises no additives. In some embodiments, virgin HDPE comprises additives such as, but not limited to, antioxidants.

As used herein, “visbreaking conditions” means thermal visbreaking and/or peroxidation visbreaking. Thermal visbreaking includes temperature, pressure, and/or mechanical shear sufficient to cause polymer chain scission to predominate of polymer chain branching or crosslinking. Peroxidation visbreaking occurs when a peroxide as added to the polymer melt in an extruder followed by thermal decomposition of the peroxide to form free radicals, which react with the polymer chain to result in chain scission. As used herein, a polymer that has been visbroken will have lower number average and weight average molecular weight, a narrower molecular weight distribution, higher melt index, and a higher high load melt index. In some embodiments, visbreaking conditions comprise a temperature in the range of from 300° C. to 350° C., from 305° C. to 345° C., from 310° C. to 340° C., or from 315° C. to 335° C., and/or adding specific energy in an amount in the range of from 0.30 kW·hr/kg to 0.60 kW·hr/kg, from 0.33 kW·hr/kg to 0.57 kW·hr/kg, from 0.37 kW·hr/kg to 0.53 kW·hr/kg, or from 0.40 kW·hr/kg to 0.50 kW·hr/kg.

As used herein, “visbreaking” means treating a polymer thermally and/or chemically to produce a reduction in Mₙ, M_{w}, and MWD (M_{w}/Mₙ), and an increase in melt index I₂ (ASTM D-1238, 2.16 kg @ 190° C.) and high load melt index 121 (ASTM D-1238, 21.6 kg @ 190° C.) of the HDPE so treated. Applying high temperatures and/or adding radical source such as peroxides to polyolefinic materials results in degradation of the polymer chains and reduction of the average molecular weight of the polymer. In parallel, the molecular weight distribution gets narrower. When intentionally performing such methods for modifying the properties of polymers, these practices are commonly called “visbreaking”.

As used herein, “visbroken HDPE recyclate” means the product obtained by subjecting an HDPE recyclate to visbreaking conditions as described herein.

### Production of Modified HDPE Recyclate

Typically, most consumer and/or industrial products are produced using virgin polymer, such as but not limited to HDPE. These consumer and/or industrial products have a limited service life either by design (e.g., food and beverage containers) or as a result of wear and tear during usage (e.g., mechanical or chemical degradation). After completion of their service life, these polymer products are sent to waste. In some cases, such waste is cleaned and separated to produce polymer recyclate. In some cases, such separations result in recovery of an HDPE recyclate. As used herein, “modified HDPE recyclate” means the product obtained by subjecting an HDPE recyclate to visbreaking conditions as described herein.

### Virgin HDPE

In some embodiments, virgin HDPE is derived from ethylene homopolymers, copolymers of units derived from ethylene and units derived from one or more of C₃-C₁₂ α-olefins, copolymers of units derived from ethylene and units derived from one or more of alpha mono-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 20 wt. %, 15 wt. %, 10 wt. %, or 5 wt. %.

Such ethylene homopolymers and/or copolymers can be produced in a suspension, solution, slurry, or gas phase process, using known equipment and reaction conditions. In some embodiments, polymerization temperatures range from about 0° C. to about 300° C. at atmospheric, subatmospheric, or superatmospheric pressures.

Slurry or solution polymerization systems can utilize subatmospheric or superatmospheric pressures and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize superatmospheric pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30°° C. to 130°° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

In some embodiments, a catalyst based on a Group VIB metal is used. In some embodiments the catalyst is a chromium-based catalyst. Such HDPE homopolymers and/or copolymers have some long-chain branching and a density in the range of from 0.940 g/cm³ to 0.970 g/cm³. Such HDPE homopolymers and/or copolymers have some long-chain branching and a density in the range of from 0.925 g/cm³ to 0.940 g/cm³.

In some embodiments, a Ziegler-Natta (ZN) catalyst is used. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such HDPE homopolymers and/or copolymers have some long-chain branching and a density in the range of from 0.940 g/cm³ to 0.970 g/cm³.

Virgin HDPE can be characterized by having:
i) a density in the range of from 0.940 g/cm³ to 0.970 g/cm³;
ii) a melt index (12; 2.16 kg, 190° C.) in the range of from 1.0 g/10 min. to 100 g/10 min., from 2.0 g/10 min. to 80 g/10 min., or from 3.0 g/10 min. to 50 g/10 min.;
iii) a molecular weight distribution (Mw/Mn) greater than 15; and
iv) a weight average molecular weight less than or equal to 250,000 daltons, less than or equal to 200,000 daltons, less than or equal to 150,000 daltons, or less than or equal to 100,000 daltons.

### HDPE Recyclate

In some embodiments, means post-consumer recycled HDPE and/or post-industrial recycled HDPE. Polyolefin recyclate is derived from an end product comprising virgin HDPE that has completed its life cycle as a consumer item and would otherwise be disposed of as waste (e.g., a polyethylene water bottle) or from plastic scrap that is generated as waste from an industrial process. Post-consumer polyolefins include polyolefins that have been collected in commercial and residential recycling programs. Such waste is typically separated through one or more separation steps to recover two main polyolefinic fractions, namely polyethylene recyclate and polypropylene recyclate. Polyethylene recyclate can be further separated to recover a portion having HDPE as the primary constituent.

HDPE recyclate, as described above, can be characterized by having:
i) a density in the range of from 0.940 g/cm³ to 0.970 g/cm³;
ii) a first high load melt index (I₂₁; 21.6 kg, 190° C.;
iii) a melt index (I₂; 2.16 kg, 190° C.) in the range of from 0.10 g/10 min. less than or equal to 1.0 g/10 min.; and
iv) a first melt index ratio (MIR, I₂₁/I₂).

In some embodiments, in addition to the foregoing properties, the HDPE recyclate can be further characterized by having one or more of:
vii) a molecular weight distribution (M_{w}/Mₙ) greater than 6.0, greater than 8.0, or greater than 10, and/or less than 25, less than 20, or less than 15;
viii) a weight average molecular weight greater than or equal to 100,000 daltons, greater than or equal to 150,000 daltons, greater than or equal to 200,000 daltons, or greater than or equal to 250,000 daltons, and/or less than or equal to 600,000 daltons, less than or equal to 500,000 daltons, less than or equal to 400,000 daltons, or less than or equal to 300,000 daltons; and
ix) a first long chain branching parameter (g′);
x) a first overall polydispersity ratio (PDR);
xi) a first complex viscosity ratio (η*_{0.1}/η*₁₀₀); and
xii) a first intrinsic viscosity.

### Visbreaking

In some embodiments, an HDPE recyclate is fed to an extruder and is subjected to visbreaking conditions and optionally devolatilization conditions. Visbreaking conditions are implemented in a visbreaking zone of an extruder and are tailored for HDPE. In some embodiments, visbreaking conditions means thermal visbreaking and/or peroxidation visbreaking. In some embodiments, visbreaking conditions consist of thermal visbreaking, wherein the temperature in the visbreaking zone is greater than or equal to 300° C., where it is believed that chain scission reactions exceed long-chain branching and/or crosslinking reactions. In some embodiments, temperatures in the visbreaking zone can be in the range of from 320° C. to 500° C., from 340° C. to 480° C., or from 360° C. to 460° C. In some embodiments, instrumentation at the first extruder discharge monitors rheology directly or indirectly (I₂, I₂₁, viscosity, melt elasticity, complex viscosity ratio, or the like) to measure and assist in control of visbreaking. In some embodiments, where antioxidant addition is used in conjunction with visbreaking, the antioxidant addition point is at a location on the first extruder after a substantial portion of the visbreaking reaction has taken place. In some embodiments, visbreaking conditions consist of thermal visbreaking the absence of or substantially in the absence of oxygen, wherein substantial absence of oxygen means less than or equal to 1.0 wt. %, less than or equal to 0.10 wt. %, or less than or equal to 0.01 wt. %, based on the total weight of polymer in the extruder. In some embodiments, the visbreaking extruder comprises one or more melt filters.

In some embodiments, visbreaking conditions comprise a temperature in the range of from 300° C. to 350° C., from 305° C. to 345° C., from 310° C. to 340° C., or from 315° C. to 335° C., and/or adding specific energy in an amount in the range of from 0.30 kW·hr/kg to 0.60 kW·hr/kg, from 0.33 kW·hr/kg to 0.57 kW·hr/kg, from 0.37 kW·hr/kg to 0.53 kW·hr/kg, or from 0.40kW·hr/kg to 0.50 kW·hr/kg.

### Modified HDPE Recyclate

In some embodiments, an HDPE recyclate is fed to a visbreaking extruder. A modified HDPE recyclate is withdrawn from the discharge of the visbreaking extruder, wherein “modified” means that the HDPE recyclate was subjected to visbreaking conditions or visbreaking conditions followed by devolatilization conditions.

Modified HDPE recyclate, as described above, can be characterized by having:
i) a density in the range of from 0.9480 g/cm³ to 0.9650 g/cm³, and/or wherein the ratio of the density of the modified HDPE recyclate to the density of the HDPE recyclate is greater than or equal to 1.0;
ii) a high load melt index (I₂₁; 21.6 kg, 190° C.) in the range of from 80 dg/min. to 4,400 dg/min., and/or wherein the ratio of the high load melt index of the modified HDPE recyclate to the high load melt index of the HDPE recyclate is greater than or equal to 2.0, greater than or equal to 3.0, or greater than or equal to 4.0;
iii) a melt index MI (I₂; 2.16 kg, 190° C.) in the range of from 2.0 dg/min. to 20 dg/min., and/or wherein the ratio of the melt index of the modified HDPE recyclate to the melt index of the HDPE recyclate is greater than or equal to 5.0;
iv) a melt index ratio (MIR, I₂₁/I₂), wherein the MIR of the modified HDPE recyclate to the MIR of the HDPE recyclate is in the range of from 30 to 50;
v) a complex viscosity (η*100) in the range of from 3,000 poise to 7,500 poise; and
vi) a melt elasticity (“ER”) in the range of from 0.75 to 1.50, and/or wherein the ratio of the ER of the modified HDPE recyclate to the ER of the HDPE recyclate is in the range of from 0.10 to 0.45, from 0.15 to 0.40, or from 0.20 to 0.35.

In some embodiments, in addition to the foregoing properties, the modified HDPE recyclate can be further characterized by having one or more of:
vii) a molecular weight distribution, wherein the ratio of molecular weight distribution of the modified HDPE recyclate to the molecular weight distribution of the HDPE recyclate is in the range of from 0.25 to 0.60, from 0.30 to 0.55, or from 0.35 to 0.50;
viii) a weight average molecular weight (“M_{w2}”), wherein the ratio of the weight average molecular weight of the modified HDPE recyclate and to the weight average molecular weight of the HDPE recyclate is in the range of from 0.10 to 0.70, from 0.15 to 0.60, or from 0.20 to 0.50; and
ix) a long chain branching parameter (g′), wherein the g′ of the modified HDPE recyclate is in the range from 0.85 to 0.97, from 0.80 to 0.98, or from 0.70 to 0.99, and/or the ratio of the g′ of modified HDPE recyclate to the g′ of the HDPE recyclate is less than or equal to 1.0;
x) a first long chain branching index (“LCBI”) greater than or equal to 0.60, and the modified HDPE recyclate has a LCBI less than or equal to 0.40;
xi) an overall polydispersity ratio (PDR), wherein the ratio of the PDR of the modified HDPE recyclate to the PDR of the HDPE recyclate is less than or equal to 0.50, less than or equal to 0.45, or less than or equal to 0.40;
xii) a complex viscosity ratio (η*_{0.1}/η*₁₀₀), wherein the ratio of the complex viscosity ratio of the modified HDPE recyclate to the complex viscosity ratio of the HDPE recyclate is less than or equal to 0.50, less than or equal to 0.40, or less than or equal to 0.30, and/or the second complex viscosity is less than or equal to 10 poise, less than or equal to 8.0 poise, or less than or equal to 6.0 poise, and η*_{0.1} is the complex viscosity at 0.1 rad/sec and η*₁₀₀ is the complex viscosity at 100 rad/sec, both at a temperature of 190° C.; and
xiii) an intrinsic viscosity [n], wherein the ratio of the intrinsic viscosity of the modified HDPE recyclate to the intrinsic viscosity of the HDPE recyclate is less than or equal to 0.90, less than or equal to 0.80, or less than or equal to 0.70.

### Blend Composition Suitable for Injection Molding Applications

A first blend component is a modified HDPE recyclate produced from a visbreaking extruder as described above. A second blend component comprises a virgin LLDPE. In some embodiments. In some embodiments, a composition, suitable for injection molding applications, comprises from 50 wt. % to 95 wt. % of a modified high density polyethylene (HDPE) recyclate, and from 5 wt. % to 50 wt. % of a linear low density polyethylene (LLDPE), wherein weight percentages are based on the total weight of the modified HDPE recyclate and the LLDPE.

### Virgin LLDPE

In some embodiments, virgin LLDPE is from ethylene homopolymers, copolymers of units derived from ethylene and units derived from one or more of C₃-C₁₂ α-olefins, copolymers of units derived from ethylene and units derived from one or more of alpha mono-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 20 wt. %, 15 wt. %, 10 wt. %, or 5 wt. %.

Such ethylene homopolymers and/or copolymers can be produced in a suspension, solution, slurry, or gas phase process, using known equipment and reaction conditions. In some embodiments, polymerization temperatures range from about 0° C. to about 300° C. at atmospheric, subatmospheric, or superatmospheric pressures.

Slurry or solution polymerization systems can utilize subatmospheric or superatmospheric pressures and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize superatmospheric pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30° C. to 130° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

In some embodiments, a Ziegler-Natta (ZN) catalyst is used. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such LLDPE homopolymers and/or copolymers have some long-chain branching and a density in the range of from 0.910 g/cm³ to 0.940 g/cm³.

Virgin LLDPE can be characterized by having:
i) a density in the range of from 0.910 g/cm³ to 0.925 g/cm³;
ii) a high load melt index HLMI (I₂₁; 21.6 kg, 190° C.) in the range of from 8.0 dg/min. to 100 dg/min.;
iii) a melt index MI (12; 2.16 kg, 190° C.) in the range of from 0.80 dg/min. to 1.20 dg/min.;
iv) a melt index ratio (HLMI/MI) in the range of from 10 to 35;
v) a complex viscosity (η*100) in the range of from 8,000 poise to 100,000 poise; and
vi) a melt elasticity (ER) in the range of from 0.10 to 0.90.

In some embodiments, in addition to the foregoing properties, the modified HDPE recyclate can be further characterized by having one or more of:
vii) a molecular weight distribution (Mw/Mn) greater than 15; and
vii) a weight average molecular weight less than or equal to 250,000 daltons, less than or equal to 200,000 daltons, less than or equal to 150,000 daltons, or less than or equal to 100,000 daltons.

### Compounding Extruder

In some embodiments, a modified HDPE recyclate and a virgin LLDPE are fed to a second extruder or mixer wherein the blend is subjected to compounding conditions. Compounding conditions are implemented in the compounding zone of the second extruder or mixer and are tailored for mixtures of specific polyolefins and optionally additives. Temperature, pressure, and shear force conditions are implemented in the second extruder or mixer sufficient to provide intimate mixing of the modified HDPE recyclate and the virgin HDPE and optionally additives to produce a substantially homogeneous polymer blend of the modified HDPE recyclate and the virgin HDPE. In some embodiments, compounding conditions comprise a temperature in the compounding zone of less than or equal to 300° C., less than or equal to 250° C. or less than or equal to 200° C. In some embodiments, temperatures in the compounding zone can be in the range of from 125° C. to 195° C., from 130° C. to 180° C., or from 135° C. to 165° C.

Blends of modified HDPE Recyclate and LLDPE Component

In some embodiments, the blend comprises from 50 wt. % to 95 wt. %, from 60 wt. % to 92.5 wt. %, from 70 wt. % to 90 wt. %, or from 75 wt. % to 85 wt. % of a modified HDPE recyclate, and from 5 wt. % to 50 wt. %, 7.5 wt. % to 40 wt. %, 10 wt. % to 30 wt. %, or 15 wt. % to 25 wt. % of the LLDPE, wherein weight percentages are based on the total weight of the modified HDPE recyclate and the LLDPE.

In some embodiments, a composition suitable for use in injection molding applications comprises a blend of a modified HDPE recyclate and an LLDPE, wherein the blend has:
i) a density in the range of from 0.949 g/cm³ to 0.954 g/cm³;
ii) a high load melt index HLMI (I₂₁; 21.6 kg, 190° C.) in the range of from 120 dg/min. to 210 dg/min.;
iii) a melt index MI (2.16 kg, 190° C.) in the range of from 2.0 dg/min. to 20 dg/min.;
iv) a melt index ratio (HLMI/MI) in the range of from 30 to 50;
v) a complex viscosity (η*100) in the range of from 5,900 poise to 10,000 poise; and
vi) a melt elasticity (ER) in the range of from 0.6 to 1.0.

In some embodiments, the composition suitable for use in injection molding applications can be further characterized by one or more of the following physical performance parameters:
i) a notched Izod greater than or equal to 1.00 ft-lb/in (0.53 N-m/cm);
ii) a NCTL at 30° C. greater than or equal to 10 hours;
iii) a flexmod 1% secant modulus greater than or equal to 190 kpsi (1,310 MPa);
iv) a container sidewall stiffness 1% secant modulus greater than or equal to 190 kpsi (1,310 MPa); and
v) a container drop at-20° C. greater than or equal to 10 ft (3.0 m).

### Production of Blend Composition Suitable for Injection Molding Applications

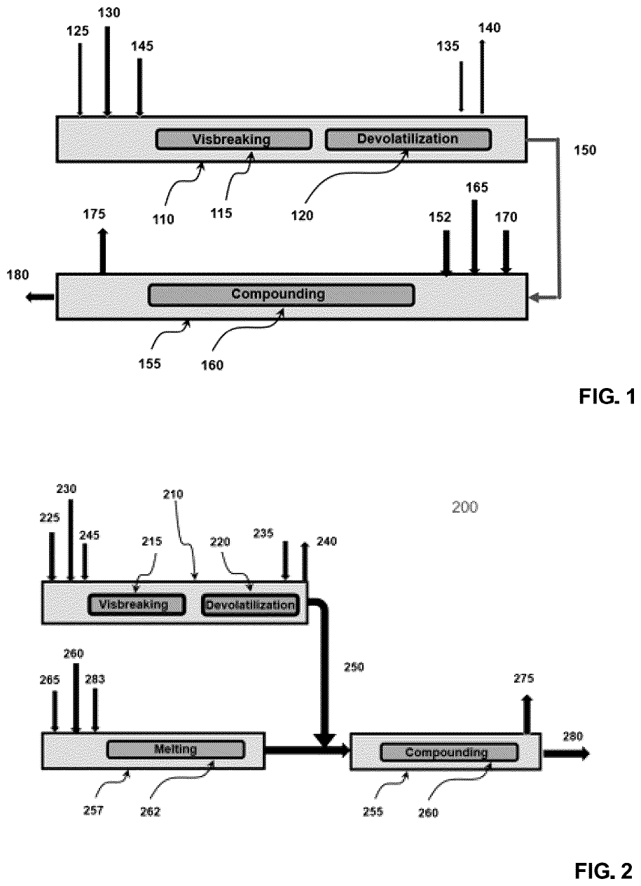

FIG. 1 and FIG. 2 show nonlimiting examples of equipment configurations that can be used for production of the blend composition disclosed herein.

In some embodiments, the LLDPE blend component can be a powder product from a polymerization apparatus, a pelletized LLDPE, or an LLDPE melt, which is the product withdrawn from a third extruder.

In some embodiments, the modified HDPE blend component and/or the LLDPE blend component can each comprise two or more polymers. The melt indexes of the blends making up each of the modified HDPE and/or LLDPE components or the melt indexes of the blends of the modified HDPE and/or LLDPE components are determined based on the logarithmic mixing rule, wherein blend components satisfy the following equation:

$$log ( {MFR}_{blend} ) = {\sum }_{i = 1}^{n} ( {w}_{i} \times log ( {MFR}_{i} ) )$$

wherein:
MFR is I₂, I₂₁, or other selected melt index;
MFR_{blend} is the target MFR of the final blend product;
n is the number of components in the blend; and
i is the i-th component of an n-component blend.

### 2-Extruder Configuration

In FIG. 1, flow diagram 100 includes a visbreaking extruder 110 and a compounding extruder 155. Embodiments of the present invention as shown in FIG. 1 include a visbreaking extruder 110 having a visbreaking zone 115 and a devolatilization zone 120. HDPE recyclate 125 is added to visbreaking extruder 110 proximate to the inlet end of the extruder. The HDPE recyclate 125 is drawn through the visbreaking extruder 110 by one or more rotating screw drives in the barrel of the visbreaking extruder 110. The length of the visbreaking extruder 110 is separated into one or more zones. Each zone can have one or more of a specified thread pitch on the screw drive, inlets for injection of gas 130, 135, vents or vacuum connections for withdrawal of gas 140, means for addition or withdrawal of heat, inlets for injection of peroxide 145, and inlets for injection of additives to impart preselected process conditions including, but not limited to pressure, temperature, and shear force.

FIG. 1 shows an embodiment with both a visbreaking zone 115 and a devolatilization zone 120. Other embodiments can have either a visbreaking zone 115 or a devolatilization zone 120 independently without the other. Process conditions in the visbreaking extruder 110 can further be controlled by rotation speed of the screw drive. Modified HDPE recyclate 150 is withdrawn proximate to the discharge of the visbreaking extruder 110 for further processing.

Embodiments of FIG. 1 include a second extruder 155, having a compounding zone 160. Modified HDPE recyclate 150 is added to compounding extruder 155 as a first blend component proximate to the inlet end of the extruder along with a polyolefin blend component 152 and subjected to compounding conditions. The polyolefin blend component 152 comprises a virgin LLDPE. The mixture of HDPE recyclate 150 and LLDPE blend component 152 is drawn through the compounding extruder 155 by one or more rotating screw drives in the barrel of the extruder 155. One or more additional inlets proximate to the inlet end of the extruder provide for the addition of antioxidant agent 165 and/or other components 170. The length of the compounding extruder 155 can be separated into one or more zones. Each zone can have one or more of a specified thread pitch on the screw drive, means for addition or withdrawal of heat, inlets for injection of additives. and vents or vacuum connections for withdrawal of gas 175, in order to impart preselected process conditions including, but not limited to pressure, temperature, and shear force. A blend 180 of the modified HDPE recyclate 150 and the LLDPE blend component 152 is withdrawn proximate to the discharge of the compounding extruder 155 for further processing or pelletization.

### 3-Extruder Configuration

In FIG. 2, flow diagram 200 includes a visbreaking extruder 210, a melting extruder 257, and a compounding extruder 255. Embodiments of the present invention as shown in FIG. 2 include a visbreaking extruder 210 having a visbreaking zone 215 and a devolatilization zone 220. HDPE recyclate 225 is added to visbreaking extruder 210 proximate to the inlet end of the extruder. The HDPE recyclate 225 is drawn through the visbreaking extruder 210 by one or more rotating screw drives in the barrel of the visbreaking extruder 210. The length of the visbreaking extruder 210 is separated into one or more zones. Each zone can have one or more of a specified thread pitch on the screw drive, inlets for injection of gas 230, 235, vents or vacuum connections for withdrawal of gas 240, means for addition or withdrawal of heat, inlets for injection of peroxide 245, and inlets for injection of additives in order to impart preselected process conditions including, but not limited to pressure, temperature, and shear force.

FIG. 2 shows an embodiment with both a visbreaking zone 215 and a devolatilization zone 220. Other embodiments can have either a visbreaking zone 215 or a devolatilization zone 220 independently without the other. Process conditions in the visbreaking extruder 210 can further be controlled by rotation speed of the screw drive. Modified HDPE recyclate 250 is withdrawn proximate to the discharge of the visbreaking extruder 210 for further processing.

Embodiments of FIG. 2 include a second extruder 255 having a compounding zone 260 and a third extruder 257 having a melting zone 262. A third blend component 283 is added to melting extruder 257 proximate to the inlet end of the extruder optionally along with antioxidant agent 265 and other components 270. The polyolefin blend component 252 comprises a virgin LLDPE. The mixture of third blend component 252 and optional antioxidant 265 and/or other components 270 is drawn through the melting extruder 257 by one or more rotating screw drives in the barrel of the melting extruder 257. The length of the melting extruder 257 can be separated into one or more zones. Each zone can have one or more of a specified thread pitch on the screw drive, means for addition or withdrawal of heat, inlets for injection of additives, and vents or vacuum connections for withdrawal of gas, in order to impart preselected process conditions including, but not limited to, pressure, temperature, and shear force. A melt of the polyolefin blend component 252 is withdrawn proximate to the discharge of the melting extruder 257 for further processing or pelletization.

Modified HDPE recyclate 250 is added to compounding extruder 255 proximate to the inlet end of the extruder along with the melt of the polyolefin blend component 252. The mixture of modified HDPE recyclate 250 and polyolefin blend component 252 is drawn through the compounding extruder 255 by one or more rotating screw drives in the barrel of the compounding extruder 255 and the mixture is subjected to compounding conditions. The length of the compounding extruder 255 can be separated into one or more zones. Each zone can have one or more of a specified thread pitch on the screw drive, means for addition or withdrawal of heat, inlets for injection of additives, and vents and/or vacuum connections for withdrawal of gas 275, in order to impart preselected process conditions including, but not limited to pressure, temperature, and shear force. A blend 280 of the modified HDPE recyclate 250 and the polyolefin blend component 252 melt is withdrawn proximate to the discharge of the compounding extruder 255 for further processing or pelletization.

### Injection Molding

Injection molding is a process wherein a polymer melt (e.g., HDPE or the blend composition disclosed herein) is produced, and the polymer melt is injected into a mold to form a desired product. This process is favored for its efficiency, repeatability, and ability to produce strong, durable molded products (e.g., pails) with precise dimensions.

Polymer pellets (e.g., HDPE or the blend composition disclosed herein) are loaded into the injection molding machine's hopper and gradually moved towards the heating barrel, where they are heated to a melting temperature. For HDPE, this temperature typically ranges from 180° C. to 280° C., depending on the grade of the polymer and the specifics of the part being molded. The lower end of the temperature range is limited by the need for the polymer to be completely melted and to be flowable enough to completely fill all voids in the mold, while the upper end of the temperature range is limited to prevent degradation of the polymer, wherein exceeding either limit will negatively affect the strength and appearance of the molded article.

As the polymer reaches its melting point, the injection molding machine uses a screw mechanism to inject the molten plastic into a mold. This mold is precision-crafted to the exact dimensions and shape of the desired article, such as a pail. The injection pressure required can be significant, often ranging from 1,000 to 1,500 bar. This high pressure ensures that the material fills every part of the mold, reaching all the corners and replicating the mold's surface texture and details.

After the HDPE is injected, it needs time to cool and solidify. This cooling phase is as crucial as the injection, as the way the pail cools can affect its final properties. Cooling must be done uniformly to prevent warping or internal stresses. If the pail cools too quickly, it might shrink unevenly, leading to a deformed product. Alternatively, cooling too slowly can make the process inefficient.

Once cooled, the mold is opened, and the newly formed molded article is ejected. In the case of a pail, the final product should now have a smooth or textured surface replicating that of the mold inner surface, with no signs of burning, discoloration, or surface imperfections. The edges and corners should be crisp, and the wall thickness should be uniform throughout.

### Certain Embodiments

A composition suitable for injection molding applications comprises a blend of at least 50 wt. % of a modified HDPE recyclate and a LLDPE, wherein weight percentage is based on the combined weight of the modified HDPE recyclate and the LLDPE. In some embodiments, the composition comprises from 50 wt. % to 95 wt. %, from 60 wt. % to 92.5 wt. %, from 70 wt. % to 90 wt. %, or from 75 wt. % to 85 wt. % of a modified HDPE recyclate, and from 5 wt. % to 50 wt. %, 7.5 wt. % to 40 wt. %, 10 wt. % to 30 wt. %, or 15 wt. % to 25 wt. % of the LLDPE, wherein weight percentages are based on the total weight of the modified HDPE recyclate and the LLDPE.

In some embodiments, in addition to the limitations of any one of the foregoing embodiments of the composition, the modified HDPE recyclate is a product of thermally visbreaking or thermal visbreaking and devolatilizing an HDPE recyclate.

In a first set of modified HDPE recyclate embodiments, in addition to the limitations of any one of the foregoing embodiments of the composition, the modified HDPE recyclate has:
a) a density in the range of from 0.9480 g/cm³ to 0.9650 g/cm³, from 0.9528 g/cm³ to 0.9645 g/cm³, from 0.9577 g/cm³ to 0.9640 g/cm³, or from 0.9625 g/cm³ to 0.9635 g/cm³; and
b) a high load melt index HLMI (21.6 kg, 190° C.) in the range of from 80 dg/min. to 4,400 dg/min., from 153 dg/min. to 3,060 dg/min., from 227 dg/min. to 1,700 dg/min., or from 300 dg/min. to 350 dg/min.

In a second set of modified HDPE recyclate embodiments, in addition to the limitations of any one of the foregoing embodiments of the composition in the first set of modified HDPE recyclate embodiments, the modified HDPE recyclate further has:
a) a melt index MI (2.16 kg, 190° C.) in the range of from 2.0 dg/min. to 20 dg/min., from 4.0 dg/min. to 18 dg/min., from 6.0 dg/min. to 16.0 dg/min., from 7.0 dg/min. to 14.0 dg/min., or from 8.0 dg/min. to 12.0 dg/min.;
b) a melt index ratio (HLMI/MI) in the range of from 30 to 50, from 31 to 48, from 33 to 46, or from 35 to 43;
c) a complex viscosity (η*100) in the range of from 3,000 poise to 7,500 poise, from 3,200 poise to 6,600 poise, from 3,400 poise to 5,700 poise, from 3,600 poise to 4,800 poise, or from 3,800 poise to 3,900 poise;
d) a melt elasticity (ER) in the range of from 0.75 to 1.50, from 0.79 to 1.36, from 0.84 to 1.22, from 0.88 to 1.08, or from 0.92 to 0.94; or
e) a combination thereof.

In first set of LLDPE embodiments, in addition to the limitations of any one of the foregoing embodiments of the composition, the LLDPE has:
a) a density in the range of from 0.910 g/cm³ to 0.925 g/cm³, from 0.913 g/cm³ to 0.924 g/cm³, from 0.917 g/cm³ to 0.922 g/cm³, or from 0.920 g/cm³ to 0.921 g/cm³; and
b) a high load melt index HLMI (21.6 kg, 190° C.) in the range of from 8.0 dg/min. to 100 dg/min., from 10.0 dg/min. to 76.0 dg/min., from 13.0 dg/min. to 53.0 dg/min., or from 15.0 dg/min. to 29.0 dg/min.

In a second set of LLDPE embodiments, in addition to the limitations of any one of the foregoing embodiments of the composition in the first set of LLDPE embodiments, the LLDPE further has:
a) a melt index MI (2.16 kg, 190° C.) in the range of from 0.80 dg/min. to 1.20 dg/min., from 0.85 dg/min. to 1.15 dg/min., from 0.90 dg/min. to 1.10 dg/min., or from 0.95dg/min. to 1.05 dg/min.;
b) a melt index ratio (HLMI/MI) in the range of from 10 to 35, from 12 to 33, from 13 to 31, or from 15 to 29;
c) a complex viscosity (η*100) in the range of from 8,000 poise to 100,000 poise, from 10,700 poise to 75,000 poise, from 13,300 poise to 50,000 poise, or from 16,000 poise to 25,000 poise;
d) a melt elasticity (ER) in the range of from 0.10 to 0.90, from 0.11 to 0.83, from 0.12 to 0.76, or from 0.13 to 0.69; or
e) a combination thereof.

In a first set of blend composition embodiments, in addition to the limitations of any one of the foregoing embodiments of the composition, the blend composition has:
a) a density in the range of from 0.949 g/cm³ to 0.954 g/cm³, from 0.950 g/cm³ to 0.953 g/cm³, or from 0.9510 g/cm³ to 0.9520 g/cm³; and
b) a high load melt index HLMI (21.6 kg, 190° C.) in the range of from 120 dg/min. to 210 dg/min., from 125 dg/min. to 200 dg/min., from 130 dg/min. to 191 dg/min., or from 135 dg/min. to 181 dg/min.

In a second set of blend composition embodiments, in addition to the limitations of any one of the foregoing embodiments of the composition in the first set of blend composition embodiments, the blend composition further has:
a) a melt index MI (2.16 kg, 190° C.) in the range of from 2.0 dg/min. to 20 dg/min., from 2.4 dg/min. to 16.1 dg/min., from 2.8 dg/min. to 12.3 dg/min., from 3.1 dg/min. to 8.4 dg/min., or from 3.5 dg/min. to 4.5 dg/min.;
b) a melt index ratio (HLMI/MI) in the range of from 30 to 50, from 31 to 48, from 33 to 46, or from 35 to 43;
c) a complex viscosity (η*100) in the range of from 5,900 poise to 10,000 poise, from 5,960 poise to 9,300 poise, from 6,020 poise to 8,600 poise, or from 6,100 poise to 7,300 poise;
d) a melt elasticity (ER) in the range of from 0.6 to 1.0, from 0.62 to 0.97, from 0.65 to 0.93, or from 0.67 to 0.90; or
e) a combination thereof.

In some embodiments, in addition to the limitations of any one of the foregoing embodiments of the composition, the composition is further characterized by one or more of the following performance parameters:
a) a notched Izod greater than or equal to 1.00 ft-lb/in (0.53 N-m/cm), greater than or equal to 1.05 ft-lb/in (0.56 N-m/cm), greater than or equal to 1.10 ft-lb/in (0.59 N-m/cm), greater than or equal to 1.15 ft-lb/in (0.61 N-m/cm), greater than or equal to 1.20 ft-lb/in (0.64 N-m/cm), greater than or equal to 1.25 ft-lb/in (0.67 N-m/cm), greater than or equal to 1.30 ft-lb/in (0.69 N-m/cm), greater than or equal to 1.35 ft-lb/in (0.72 N-m/cm), greater than or equal to 1.40 ft-lb/in (0.75 N-m/cm), greater than or equal to 1.45 ft-lb/in (0.77 N-m/cm), greater than or equal to 1.50 ft-lb/in (0.80 N-m/cm), greater than or equal to 1.55 ft-lb/in (0.83 N-m/cm), greater than or equal to 1.60 ft-lb/in (0.85 N-m/cm), or greater than or equal to 1.65 ft-lb/in (0.88 N-m/cm), and/or up to 3.00 ft-lb/in (1.60 N-m/cm) or 2.00 ft-lb/in (1.07 N-m/cm);
b) a NCTL at 30° C. greater than or equal to 10 hours, greater than or equal to 20 hours, greater than or equal to 25 hours, greater than or equal to 35 hours, and/or up to 50 hours or 40 hours;
c) a flexmod 1% secant modulus greater than or equal to 190 kpsi (1,310 MPa), greater than or equal to 191 kpsi (1,317 MPa), or greater than or equal to 191 kpsi (1,324 MPa), and/or up to 300 kpsi (2,068 MPa), 250 kpsi (1,724 MPa), or 200 kpsi (1,379 MPa);
d) a container sidewall stiffness 1% secant modulus greater than or equal to 190 kpsi (1,310 MPa), greater than or equal to 191 kpsi (1,317 MPa), or greater than or equal to 191 kpsi (1,324 MPa), and/or up to 300 kpsi (2,068 MPa), 250 kpsi (1,724 MPa), or 200 kpsi (1,379 MPa); and
e) a container drop at-20° C. greater than or equal to 10 ft (3.0 m), greater than or equal to 15 ft (4.6 m), greater than or equal to 20 ft (6.1 m), and/or up to 30 ft (9.1 m), or 25 ft (7.6 m).

In some embodiments, one or more molded articles, such as pail, are formed by injection molding using any one of the foregoing embodiments of the composition.

In some embodiments, a method for producing a composition useful injection molding using a high density polyethylene (HDPE) recyclate is disclosed, the method comprising:
a) providing a HDPE recyclate having a MI (2.16 kg, 190° C.) in the range of from 0.1 dg/min. to 1.0 dg/min.;
b) subjecting the HDPE recyclate to visbreaking conditions to produce a modified HDPE recyclate having a MI (2.16 kg, 190° C.) in the range of from 2.0 dg/min. to 20 dg/min.; and
c) blending the modified HDPE recyclate with a linear low density polyethylene (LLDPE) to produce the composition.

In some embodiments, in addition to the limitations of any one of the foregoing embodiments of the method, visbreaking conditions comprise thermal visbreaking or thermal visbreaking and devolatilization.

In some embodiments, in addition to the limitations of any one of the foregoing embodiments of the method, the composition comprises from 50 wt. % to 95 wt. %, from 60 wt. % to 92.5 wt. %, from 70 wt. % to 90 wt. %, or from 75 wt. % to 85 wt. % of a modified HDPE recyclate, and from 5 wt. % to 50 wt. %, 7.5 wt. % to 40 wt. %, 10 wt. % to 30 wt. %, or 15 wt. % to 25 wt. % of the LLDPE, wherein weight percentages are based on the total weight of the modified HDPE recyclate and the LLDPE.

In a first subset of method embodiments, in addition to the limitations of any one of the foregoing embodiments of the method, the modified HDPE recyclate has one of more of:
a) a density in the range of from 0.9480 g/cm³ to 0.9650 g/cm³, from 0.9528 g/cm³ to 0.9645 g/cm³, from 0.9577 g/cm³ to 0.9640 g/cm³, or from 0.9625 g/cm³ to 0.9635 g/cm³; and
b) a high load melt index HLMI (21.6 kg, 190° C.) in the range of from 80 dg/min. to 4,400 dg/min., from 153 dg/min. to 3,060 dg/min., from 227 dg/min. to 1,700 dg/min., or from 300 dg/min. to 350 dg/min.

In some embodiments, in addition to the limitations of any one of the foregoing embodiments of the methods in the first subset of method embodiments, the modified HDPE recyclate further has:
a) a melt index MI (2.16 kg, 190° C.) in the range of from 2.0 dg/min. to 20 dg/min., from 4.0 dg/min. to 18 dg/min., from 6.0 dg/min. to 16.0 dg/min., from 7.0 dg/min. to 14.0 dg/min., or from 8.0 dg/min. to 12.0 dg/min.;
b) a melt index ratio (HLMI/MI) in the range of from 30 to 50, from 31 to 48, from 33 to 46, or from 35 to 43;
c) a complex viscosity (η*100) in the range of from 3,000 poise to 7,500 poise, from 3,200 poise to 6,600 poise, from 3,400 poise to 5,700 poise, from 3,600 poise to 4,800 poise, or from 3,800 poise to 3,900 poise;
d) a melt elasticity (ER) in the range of from 0.75 to 1.50, from 0.79 to 1.36, from 0.84 to 1.22, from 0.88 to 1.08, or from 0.92 to 0.94; or
e) a combination thereof.

In second subset of embodiments, in addition to the limitations of any one of the foregoing embodiments of the method, the LLDPE has:
a) a density in the range of from 0.910 g/cm³ to 0.925 g/cm³, from 0.913 g/cm³ to 0.924 g/cm³, from 0.917 g/cm³ to 0.922 g/cm³, or from 0.920 g/cm³ to 0.921 g/cm³; and
b) a high load melt index HLMI (21.6 kg, 190° C.) in the range of from 8.0 dg/min. to 100 dg/min., from 10.0 dg/min. to 76.0 dg/min., from 13.0 dg/min. to 53.0 dg/min., or from 15.0 dg/min. to 29.0 dg/min.

In some embodiments, in addition to the limitations of any one of the foregoing embodiments of the methods in the second subset of method embodiments, the LLDPE further has:
a) a melt index MI (2.16 kg, 190° C.) in the range of from 0.80 dg/min. to 1.20 dg/min., from 0.85 dg/min. to 1.15 dg/min., from 0.90 dg/min. to 1.10 dg/min., or from 0.95 dg/min. to 1.05 dg/min.;
b) a melt index ratio (HLMI/MI) in the range of from 10 to 35, from 12 to 33, from 13 to 31, or from 15 to 29;
c) a complex viscosity (η*100) in the range of from 8,000 poise to 100,000 poise, from 10,700 poise to 75,000 poise, from 13,300 poise to 50,000 poise, or from 16,000 poise to 25,000 poise;
d) a melt elasticity (ER) in the range of from 0.10 to 0.90, from 0.11 to 0.83, from 0.12 to 0.76, or from 0.13 to 0.69; or
e) a combination thereof.

In a third subset of embodiments, in addition to the limitations of any one of the foregoing embodiments of the method, the composition has:
a) a density in the range of from 0.949 g/cm³ to 0.954 g/cm³, from 0.950 g/cm³ to 0.953 g/cm³, or from 0.9510 g/cm³ to 0.9520 g/cm³; and
b) a high load melt index HLMI (21.6 kg, 190° C.) in the range of from 120 dg/min. to 210 dg/min., from 125 dg/min. to 200 dg/min., from 130 dg/min. to 191 dg/min., or from 135 dg/min. to 181 dg/min.

In some embodiments, in addition to the limitations of any one of the foregoing embodiments of the methods in the third subset of method embodiments, the composition further has:
a) a melt index MI (2.16 kg, 190° C.) in the range of from 2.0 dg/min. to 20 dg/min., from 2.4 dg/min. to 16.1 dg/min., from 2.8 dg/min. to 12.3 dg/min., from 3.1 dg/min. to 8.4 dg/min., or from 3.5 dg/min. to 4.5 dg/min.;
b) a melt index ratio (HLMI/MI) in the range of from 30 to 50, from 31 to 48, from 33 to 46, or from 35 to 43;
c) a complex viscosity (η*100) in the range of from 5,900 poise to 10,000 poise, from 5,960 poise to 9,300 poise, from 6,020 poise to 8,600 poise, or from 6,100 poise to 7,300 poise;
d) a melt elasticity (ER) in the range of from 0.6 to 1.0, from 0.62 to 0.97, from 0.65 to 0.93, or from 0.67 to 0.90; or
e) a combination thereof.

In some embodiments, in addition to the limitations of any one of the foregoing embodiments of the method, the composition is further characterized by one or more of the following performance parameters:
a) a notched Izod greater than or equal to 1.00 ft-lb/in (0.53 N-m/cm), greater than or equal to 1.05 ft-lb/in (0.56 N-m/cm), greater than or equal to 1.10 ft-lb/in (0.59 N-m/cm), greater than or equal to 1.15 ft-lb/in (0.61 N-m/cm), greater than or equal to 1.20 ft-lb/in (0.64 N-m/cm), greater than or equal to 1.25 ft-lb/in (0.67 N-m/cm), greater than or equal to 1.30 ft-lb/in (0.69 N-m/cm), greater than or equal to 1.35 ft-lb/in (0.72 N-m/cm), greater than or equal to 1.40 ft-lb/in (0.75 N-m/cm), greater than or equal to 1.45 ft-lb/in (0.77 N-m/cm), greater than or equal to 1.50 ft-lb/in (0.80 N-m/cm), greater than or equal to 1.55 ft-lb/in (0.83 N-m/cm), greater than or equal to 1.60 ft-lb/in (0.85 N-m/cm), or greater than or equal to 1.65 ft-lb/in (0.88 N-m/cm), and/or up to 3.00 ft-lb/in (1.60 N-m/cm) or 2.00 ft-lb/in (1.07 N-m/cm);
b) a NCTL at 30° C. greater than or equal to 10 hours, greater than or equal to 20 hours, greater than or equal to 25 hours, greater than or equal to 35 hours, and/or up to 50 hours or 40 hours;
c) a flexmod 1% secant modulus greater than or equal to 190 kpsi (1,310 MPa), greater than or equal to 191 kpsi (1,317 MPa), or greater than or equal to 191 kpsi (1,324 MPa), and/or up to 300 kpsi (2,068 MPa), 250 kpsi (1,724 MPa), or 200 kpsi (1,379 MPa);
d) a container sidewall stiffness 1% secant modulus greater than or equal to 190 kpsi (1,310 MPa), greater than or equal to 191 kpsi (1,317 MPa), or greater than or equal to 191 kpsi (1,324 MPa), and/or up to 300 kpsi (2,068 MPa), 250 kpsi (1,724 MPa), or 200 kpsi (1,379 MPa); and
e) a container drop at-20° C. greater than or equal to 10 ft (3.0 m), greater than or equal to 15 ft (4.6 m), greater than or equal to 20 ft (6.1 m), and/or up to 30 ft (9.1 m), or 25 ft (7.6 m).

In some embodiments, in addition to the limitations of any one of the foregoing embodiments of the method, the method further comprises injecting the blend composition into a mold at a temperature sufficient to completely melt the composition but insufficient to degrade the composition and at a pressure sufficient to fill the mold completely.

The following examples illustrate the invention; however, those skilled in the art will recognize numerous variations within the spirit of the invention and scope of the claims. To facilitate a better understanding of the present invention, the following examples of preferred embodiments are given. In no way should the following examples be read to limit, or to define, the scope of the invention.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The following examples use commercial HDPE compositions having a low melt index as proxies for HDPE recyclates. After processing, as described herein, the modified low melt index HDPEs, either alone or in blends with other components, are compared to higher melt index virgin HDPEs.

### Test Methods

Complex viscosity (“η*”) was determined by ASTM D-4440.

Container Drop is measured using samples of polymers formed into 16 oz. deli type thin wall injection molded (TWIM) container. Containers were filled with a 50/50 mixture of propylene glycol and water, then capped with a corresponding lid and placed into a freezer set at the desired temperature. The containers are conditioned overnight at the specified temperature (below 0° C.). Mean Failure Height is determined by ASTM D5276-“Standard Test Method for Drop Test of Loaded Containers by Free Fall.” This test is specifically designed to evaluate the ability of a container to withstand the impacts during handling and/or shipping.

Container Sidewall Stiffness is measured by D790-17 “Standard Test Methods for Flexural Properties of Unreinforced and Reinforced Plastics and Electrical Insulating Materials.”

Flexural Modulus (“flexmod”) is a parameter measured in materials testing, particularly for plastics, to evaluate their stiffness or rigidity under flexural (bending) stress. This test was performed according to ASTM D790-“Standard Test Methods for Flexural Properties of Unreinforced and Reinforced Plastics and Electrical Insulating Materials.” The flexural modulus of a material is a measure of its stiffness when it is bent and is calculated from the slope of the initial linear portion of the stress-strain curve in a flexural test. The higher the flexural modulus, the stiffer the material. The 1% secant modulus specifically refers to the modulus calculated at 1% strain. A secant modulus is obtained by drawing a line (secant) from the origin of the stress-strain curve to a point on the curve corresponding to a specified strain (in this case, 1%) and measuring the slope of this line. This method provides a more practical measure of stiffness for materials that do not exhibit a perfectly linear elastic region in their stress-strain curve.

High load melt index (“I₂₁”) was determined by ASTM D-1238-F (190° C./21.6 kg).

Shear rheological measurements are performed in accord with ASTM 4440-95a, which characterize dynamic viscoelastic properties (storage modulus, G′, loss modulus, G″ and complex viscosity, η*, as a function of oscillation frequency, ω). A rotational rheometer (TA Instruments) is used for the rheological measurements. A 25 mm parallel-plate fixture was utilized. Samples were compression molded in disks (˜29 mm diameter and ˜1.3 mm thickness) using a hot press at 190° C. An oscillatory frequency sweep experiment (from 398.1 rad/s to 0.0251 rad/s) was applied at 190° C. The applied strain amplitude is ˜10% and the operating gap is set at 1 mm. Nitrogen flow was applied in the sample chamber to minimize thermal oxidation during the measurement.

Melt elasticity (“ER”) is determined as discussed in R. Shroff and H. Mavridis, “New Measures of Polydispersity from Rheological Data on Polymer Melts,” J. Applied Polymer Science 57 (1995) 1605. See also U.S. Pat. Nos. 7,238,754, 6, 171,993 and 5,534,472 (col. 10, lines 20-30), the teachings of which are incorporated herein by reference. Thus, storage modulus (G′) and loss modulus (G″) are measured. The nine lowest frequency points are used (five points per frequency decade) and a linear equation is fitted by least-squares regression to log G′ versus log G″. ER is then calculated from:

$$ER = ( 1.781 \times {10}^{- 3} ) \times {G}^{′}$$

at a value of G″=5,000 dyn/cm². The same procedure and equation for the ER calculation was used for both linear and long-chain-branched polyolefins.

PDR, or “Overall Polydispersity Measure” is determined as discussed in R. Shroff and H. Mavridis, “New Measures of Polydispersity from Rheological Data on Polymer Melts,” J. Applied Polymer Science 57 (1995) 1605, equation 27 on page 1619, with G*_{ref.1}=1.95*10⁴ dyn/cm² and log₁₀(G*_{ref.3}/G*_{ref.1})=2. The same procedure and equation for the PDR calculation was used for both linear and long-chain-branched polyolefins.

The ratio η_{0.1}/η₁₀₀ of complex viscosities, η*_{0.1}, at a frequency of 0.1 rad/sec and η*₁₀₀, at a frequency of 100 rad/sec, is used as an additional measure of shear sensitivity and thus rheological breadth, or polydispersity, of the polymer melt.

Melt index (“I₂”) was determined by ASTM D-1238-E (190° C./2.16 kg).

Molecular weight distribution (“MWD”) as well as the molecular weight averages (number-average molecular weight, Mₙ. weight-average molecular weight, M_{w}, and z-average molecular weight, M_{z}) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z},MWD, and short chain branching (SCB) profiles are reported using the IR detector, whereas long chain branch parameter, g′, is determined using the combination of viscometer and IR detector at 145° C. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer is weighted in a 10 mL vial and sealed for the GPC measurement. The dissolution process is obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns are calibrated based on twelve monodispersed polystyrene (PS) standards (provided by PSS) ranging from 578 g/mole to 3,510,000 g/mole. The comonomer compositions (or SCB profiles) are reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique. GPC one software was used to analyze the data. The long chain branch parameter, g′, is determined by the equation:

$${g}^{′} = [ η ] / {[ η ]}_{lin}$$

where, [η] is the average intrinsic viscosity of the polymer that is derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation ([η]ₗᵢₙ=ΣKMᵢ^{α}) for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Notched Constant Tensile Load (“NCTL”) is a method used to assess the environmental stress crack resistance (ESCR) of polyethylene and other polyolefin plastics. The specific ASTM standard for this test is ASTM D5397—Standard Test Method for Evaluation of Stress Crack Resistance of Polyolefin Geomembranes Using Notched Constant Tensile Load Test (NCTL).

Notched Izod impact test is a standard method used to determine the impact resistance of materials, particularly polymers. The specific ASTM standard for this test is ASTM D256-“Standard Test Methods for Determining the Izod Pendulum Impact Resistance of Plastics.”

Zero-shear viscosity, η₀, is determined using the Sabia equation fit of dynamic complex viscosity versus radian frequency, as described in of Shroff & Mavridis, (1999) “A Long Chain Branching Index for Essentially Linear Polyethylenes”, Macromolecules, 32, 8454-8464 (with focus on Appendix B), the disclosure of which is fully incorporated by reference herein in its entirety.

LCBI is determined using equation 13:

$$LCBI = \frac{{η}_{0}^{0.179}}{[ η ]} \frac{1}{4.8} - 1 \qquad ( 13 )$$

Equation 13 and its application are described in of Shroff & Mavridis, (1999) “A Long Chain Branching Index for Essentially Linear Polyethylenes”, Macromolecules, 32, 8454-8464, the disclosure of which is fully incorporated by reference herein in its entirety.

Long Chain Branching frequency, characterized by the ratio of Long Chain Branches per million carbon atoms, or LCB/10⁶ C, was determined by the method of Janzen & Colby (J. Janzen and R. H. Colby, “Diagnosing long-chain branching in polyethylenes”, Journal of Molecular Structure, Vol 485-486, 10 Aug. 1999, Pages 569-583), using eqs. (2-3) and the constants of Table 2 in the above reference. Specifically, the zero-shear viscosity at 190° C., η*₀, is determined by extrapolation of the complex viscosity data via the Sabia equation, as described separately. The weight-average-molecular weight, Mw, is determined via GPC. With these two parameters and the methodology of Janzen & Colby, the Long Chain Branching frequency, LCB/10⁶ C, can be determined numerically such that all 3 parameters (η₀, M_{w} and LCB/10⁶ C) satisfy eqs. (2-3) in the above reference. The Janzen & Colby methodology predicts that the ratio, η₀/η_{0,linear} of the zero-shear viscosity of the material, over the zero-shear viscosity of a perfectly linear polymer (LCB/10⁶ C=0) of the same average molecular weight, exhibits a maximum at a certain value of LCB/10⁶ C and therefore for every value of η₀/η_{0,linear}, there exist two levels, or values, of LCB/10⁶ C that such ratio is possible. For the purposes of the present calculations, the lowermost value of LCB/10⁶ C was always selected at the given ratio of η₀/η_{0,linear}.

### Raw and Prepared Materials

Raw and prepared materials used in the examples are shown in Table 1, below.

HD1vb was prepared by visbreaking portions of HD1. Visbreaking was performed by feeding HD1 into a Werner and Pfleiderer ZSK40 twin screw extruder at a melt temperature of greater than or equal to 300° C. with specific energy (“SPE”) input to the polymer in the range of from 0.45 kW·hr/kg to 0.50 kW·hr/kg.

TABLE 1

| Composition | Grade/Description | Label | Available From |
|---|---|---|---|
| HDPE¹ | Petrothene ™ LM600700 | HD1 | LyondellBasell Industries NV |
| Modified | Visbroken HD1 | HD1vb | Prepared by LyondellBasell |
| HDPE | | | |
| LLDPE | Exceed ™ 1018CA² | LL1 | ExxonMobil Chemical Co. |
| LLDPE | Petrothene ™ GA1810^{3, 4} | LL2 | LyondellBasell Industries NV |
| HDPE | Marlex ™ 9006 | HD2 | Chevron Phillips Chemical |
| | | | Company LLC |
| HDPE | Alathon ™ M5266 | HD3 | LyondellBasell Industries NV |
| HDPE | Alathon ™ M5370 | HD4 | LyondellBasell Industries NV |
| HD1vb/LL1 | 80 wt. % HD1vb/20 wt. % | BL1 | Prepared by LyondellBasell |
| | LL1 blend | | |
| HD1vb/LL2 | 80 wt. % HD1vb/20 wt. % | BL2 | Prepared by LyondellBasell |
| | LL2 blend | | |

¹Proxy for homopolymer recyclate
²metallocene-catalyzed LLDPE (mLLDPE)
³Or equivalent Petrothene ™ GA601, available from LyondellBasell Industries NV
⁴Ziegler-Natta-catalyzed LLDPE (znLLDPE)

Measured physical properties of the raw and prepared materials listed in Table 1 are shown in Table 2, below. Table 2 shows the property changes achieved by visbreaking HD1 to form HD1vb. Higher values of HLMI/MI for BL1 and BL2 indicate that the inventive blends have improved processability compared to the benchmark comparative grades.

TABLE 2

| | HD2 | HD3 | HD4 | BL2 | BL1 | HD1vb | HD1 | LL2 | LL1 |
|---|---|---|---|---|---|---|---|---|---|
| Avg. | 0.9503 | 0.9523 | 0.9517 | 0.9533 | 0.9515 | 0.9605 | 0.9635 | 0.9205 | 0.9202 |
| Density | | | | | | | | | |
| (g/cc) | | | | | | | | | |
| MI (g/10 | 6.63 | 6.23 | 6.49 | 4.25 | 3.81 | 9.10 | 0.764 | 1.01 | 1.00 |
| min) | | | | | | | | | |
| HLMI (g/10 | 167 | 182 | 185 | 181 | 135 | 334 | 55.3 | 28.8 | 15.8 |
| min) | | | | | | | | | |
| HLMI/MI | 25.2 | 29.2 | 28.5 | 42.6 | 35.4 | 36.7 | 72.4 | 28.5 | 15.8 |
| LCBI | −0.02 | 0.03 | 0.02 | 0.26 | 0.24 | 0.39 | 0.69 | 0.05 | −0.09 |
| LCB/10³ C | 16 | 12 | 12 | 42 | 46 | 100 | 31 | 10 | 9 |
| M_{w} | 81,100 | 92,500 | 91,300 | 75,800 | 73,800 | 59,200 | 130,600 | 131,900 | 126,300 |
| [η] | 1.16 | 1.18 | 1.18 | 1.07 | 1.08 | 0.83 | 1.59 | 1.62 | 1.70 |
| [η]ₗᵢₙ | 1.22 | 1.31 | 1.30 | 1.17 | 1.17 | — | — | 1.74 | 1.78 |
| g′ | 0.95 | 0.90 | 0.91 | 0.92 | 0.92 | — | — | 0.93 | 0.96 |
| η₀ (poise) | 1.35E+04 | 1.92E+04 | 1.77E+04 | 3.42E+04 | 3.22E+04 | 1.40E+04 | 1.61E+06 | 1.26E+05 | 7.44E+04 |
| η*₁₀₀ (poise) | 5,710 | 5,550 | 5,850 | 6,160 | 7,200 | 3,870 | 10,800 | 16,700 | 24,100 |
| PDR | 2.73 | 3.76 | 3.53 | 6.29 | 4.72 | 5.63 | 1.89 | 3.93 | 2.20 |
| ER | 0.50 | 0.96 | 0.81 | 0.90 | 0.67 | 0.93 | 3.63 | 0.68 | 0.14 |

Dynamic oscillatory data generated based on analysis of samples of HD2, BL1, and BL2 are shown in FIG. 1. The curves in FIG. 1 show that complex viscosity decreases as frequency increases for HD2, BL1, and BL2. The rheology data further shows that the PCR blend compositions, BL1 and BL2, flow similarly to benchmark polymer HD2 at high shear rates relevant to injection molding, indicated by a frequency of about 100 rad/sec on FIG. 1.

FIG. 2 indicates that BL1 and BL2 have sufficiently narrow rheological polydispersity compared to benchmark polymer HD2, indicating that all three polymers are suitable for injection molding. FIG. 2 further shows that BL2 has a narrower rheological polydispersity than BL1, as indicated by indicated by a steeper slope at initial frequencies and higher viscosities at low frequencies, suggesting that a metallocene-catalyzed LLDPE provides some improvement over the Ziegler-Natta-catalyzed LLDPE.

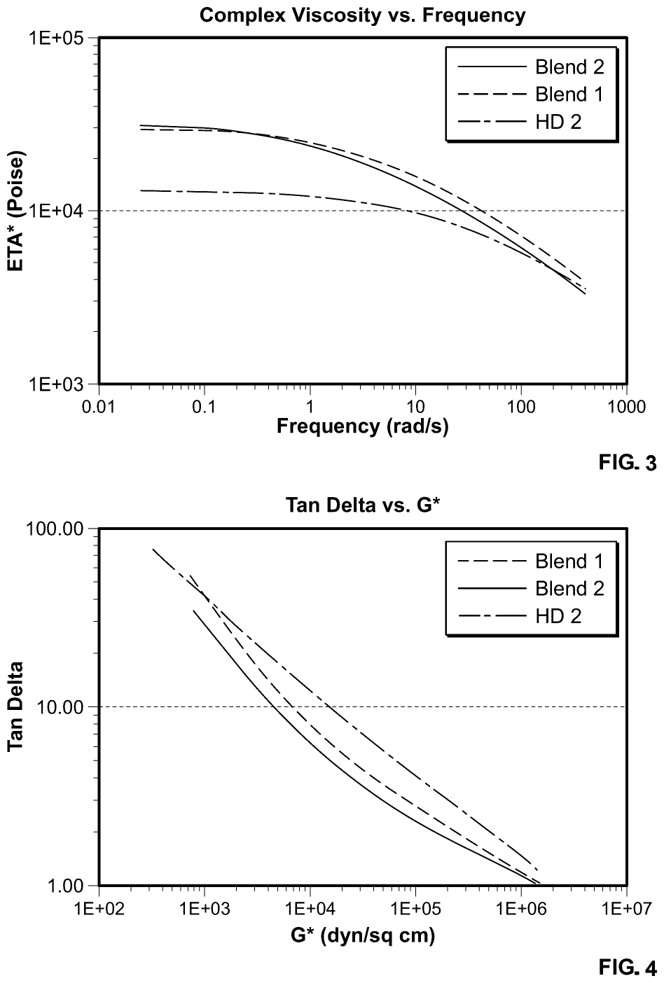

Notched Izod impact strength tests were performed at 23° C. to assess the impact strength of benchmark polymers HD2, HD3, and HD4 and inventive blends BL1 and BL2. Results of these tests are shown in Table 3 below and are shown graphically in FIG. 3. Inventive blend BL1 outperforms all of the other examples, while inventive blend BL2 performs equivalently to benchmark polymer HD3. Test results indicate that both inventive blends BL1, using Ziegler-Natta-catalyzed LLDPE, and BL2, using metallocene-catalyzed LLDPE, outperform all benchmark polymers HD2, HD3, and HD4. It is noted in all cases that the type of failure was complete separation.

TABLE 3

| | Units | HD2 | HD3 | HD4 | BL2 | BL1 |
|---|---|---|---|---|---|---|
| Notched Izod | ft- | 0.98 | 0.86 | 0.85 | 1.16 | 1.67 |
| Impact Strength | lb/in | | | | | |
| at 23° C.¹ | N- | 0.52 | 0.46 | 0.45 | 0.62 | 0.89 |
| | m/cm | | | | | |

¹average of 5 tests

Notched constant tensile load (NCTL) tests were performed at 30° C. and 10% Igepal to assess the environmental stress crack resistance (ESCR) of benchmark polymers HD2, HD3, and HD4 and inventive blends BL1 and BL2. The specific conditions of 30° C. and 10% Igepal are designed to simulate a standard environment where the material might be used. The temperature of 30° C. is a typical ambient temperature, and the 10% concentration of Igepal provides a consistent, aggressive environment for accelerating stress crack formation. Results of these tests are shown in Table 4 below and are shown graphically in FIG. 4. Inventive blend BL1 outperforms all of the other examples, while inventive blend BL2 performs equivalently to benchmark polymer HD3.

TABLE 4

| | Units | HD2 | HD3 | HD4 | BL2 | BL1 |
|---|---|---|---|---|---|---|
| Avg Failure | hr | 20.3 | 10.7 | 19.4 | 10.7 | 28.7 |
| Time¹ | | | | | | |
| Std Dev | hr | 2.466 | 0.965 | 1.338 | 0.358 | 4.495 |

¹average of 5 tests

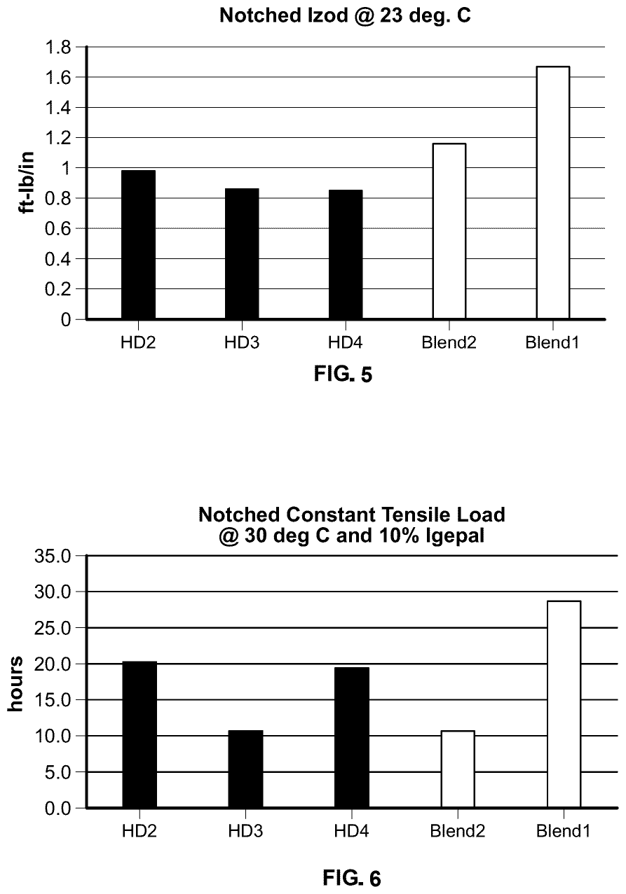

Flexural testing was performed by evaluating samples of benchmark polymers HD2, HD3, and HD4 and inventive blends BL1 and BL2. Average results of 5 tests of each sample along with the standard deviation are shown in Table 5 below. Results for 1% secant modulus are shown graphically in FIG. 5, which shows that inventive blends BL1 and BL2 outperform benchmark polymers HD2 and HD3 and are competitive with benchmark polymer HD4.

TABLE 5

| | Units | HD2 | HD3 | HD4 | BL2 | BL1 |
|---|---|---|---|---|---|---|
| 1% Secant | kpsi | 184.7 | 187.9 | 198.3 | 194.1 | 193.1 |
| Modulus | MPa | 1,273 | 1,296 | 1,367 | 1,338 | 1,331 |
| 1% Sec. Mod. SD | kpsi | 0.85 | 2.10 | 1.88 | 0.83 | 2.09 |
| | MPa | 5.9 | 14 | 13 | 5.8 | 14 |
| 2% Secant | kpsi | 153.9 | 156.8 | 165.6 | 161.3 | 160.7 |
| Modulus | MPa | 1,061 | 1,081 | 1,142 | 1,112 | 1,108 |
| 2% Sec. Mod. SD | kpsi | 0.67 | 1.45 | 1.38 | 0.57 | 1.39 |
| | MPa | 4.6 | 10 | 10 | 3.9 | 10 |
| Youngs Modulus | kpsi | 218.5 | 223.6 | 235.2 | 229.0 | 227.9 |
| | MPa | 1,507 | 1,542 | 1,622 | 1,579 | 1,571 |
| Youngs Mod. SD | kpsi | 2.68 | 2.85 | 3.28 | 2.27 | 6.62 |
| | MPa | 18 | 20 | 23 | 16 | 46 |

Container Sidewall Stiffness testing was performed by evaluating the flexural performance of 16 oz. deli containers formed from benchmark polymers HD3 and HD4 and inventive blends BL1 and BL2. Average results of 5 tests of each sample along with the standard deviation are shown in Table 6 below. Results of these tests are shown graphically in FIG. 6. For container sidewall modulus in the axial direction, the higher the modulus, the higher the stacking resistance with all else being equal. The 16 oz. deli containers made for this study showed both BL1 and BL2 had performance equivalent to or better than benchmark polymer HD4, and BL2 had performance nearly equivalent to benchmark polymer HD3.

TABLE 6

| | Units | HD3 | HD4 | BL2 | BL1 |
|---|---|---|---|---|---|
| 1% | kpsi | 295.2 | 261.6 | 262.8 | 284.6 |
| Secant | MPa | 2,035 | 1,804 | 1,812 | 1,962 |
| Modulus | | | | | |
| 1% Sec. | kpsi | 17.60 | 9.190 | 8.26 | 7.65 |
| Mod. SD | MPa | 121 | 63 | 57 | 53 |
| 2% | kpsi | 244.1 | 218.0 | 223.8 | 241.7 |
| Secant | MPa | 1,683 | 1,503 | 1,543 | 1,666 |
| Modulus | | | | | |
| 2% Sec. | kpsi | 15.20 | 6.85 | 4.83 | 6.18 |
| Mod. SD | MPa | 105 | 47 | 33 | 43 |

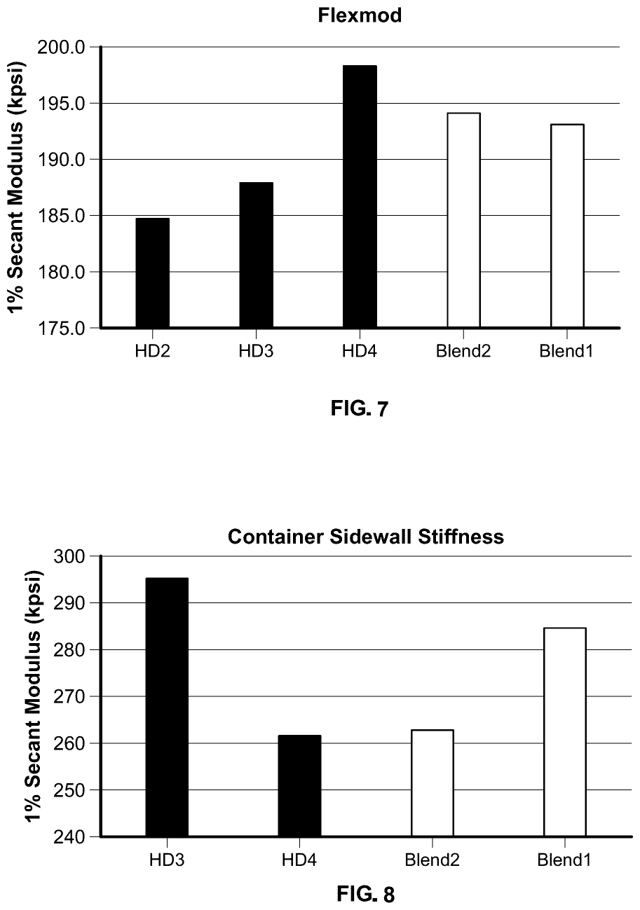

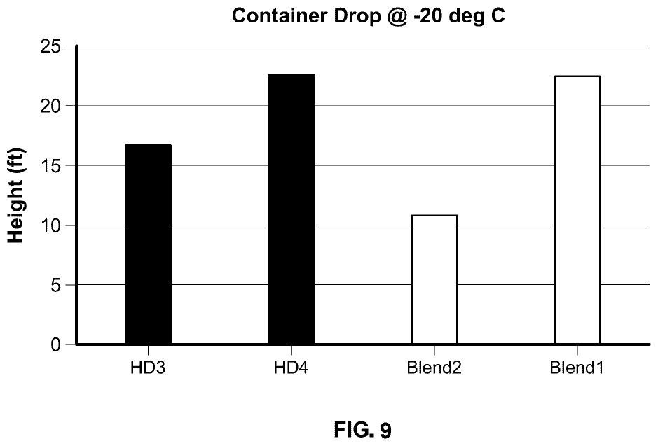

Container drop testing was performed by evaluating the drop impact performance of 16 oz. deli containers formed from benchmark polymers HD3 and HD4 and inventive blends BL1 and BL2. Results of these tests are shown in Table 7 below and are shown graphically in FIG. 7. BL1 with its Ziegler-Natta-catalyzed LLDPE lagged the performance of the benchmark polymers HD3 and HD4 but still shows utility for the application. BL2 with its metallocene-catalyzed LLDPE performed equivalently to benchmark polymer HD4 the performance of the benchmark polymers HD3 and HD4 but still shows utility for the application.

TABLE 7

| | Units | HD3 | HD4 | BL2 | BL1 |
|---|---|---|---|---|---|
| Mean Failure | ft | 17 | 23 | 11 | 23 |
| Height¹ | m | 5.2 | 7.0 | 3.4 | 7.0 |

¹average of 25 tests

Tensile testing was performed comparing benchmark polymers HD2, HD3, and HD4 and inventive blends BL1 and BL2. Average results of 5 tests of each sample along with the standard deviation are shown in Table 8 below. Test results indicate that both BL1 and BL2 had performance competitive with all benchmark polymers HD2, HD3, and HD4.

TABLE 8

| | Units | HD2 | HD3 | HD4 | BL2 | BL1 |
|---|---|---|---|---|---|---|
| Tensile at Yield | psi | 3,820 | 3,820 | 3,940 | 3,850 | 3,850 |
| | MPa | 26.3 | 26.3 | 27.2 | 26.5 | 26.5 |
| Tensile at Yield | psi | 67 | 33 | 38 | 44 | 32 |
| SD | kPa | 462 | 228 | 262 | 303 | 221 |
| Elongation at | % | 9.5 | 9.5 | 9.4 | 9.2 | 8.9 |
| Yield | | | | | | |
| Elong. at Yield | % | 0.27 | 0.24 | 0.26 | 0.44 | 0.21 |
| SD | | | | | | |

In summary, the foregoing examples show that blends of visbroken HDPE recyclate with LLDPE in the proper proportions can compete with and in some cases surpass performance of traditional virgin HDPE polymers with respect to processability and key performance attributes related to injection molded pails.

For the sake of brevity, only certain ranges are explicitly disclosed herein. However, in addition to the limitations of recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, compositions, means, methods, and/or steps described in the specification. As one of the ordinary skill in the art will readily appreciate from the disclosure of the present invention, processes, machines, compositions, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, compositions, means, methods, and/or steps.

What is claimed is:

1. A composition suitable for injection molding applications, the composition comprising:
a) from 50 wt. % to 95 wt. % of a modified high density polyethylene (HDPE) recyclate; and
b) from 5 wt. % to 50 wt. % of a linear low density polyethylene (LLDPE);
wherein weight percentages are based on the total weight of the modified HDPE recyclate and the LLDPE.

2. The composition of claim 1, wherein the modified HDPE recyclate is a product of thermally visbreaking or thermal visbreaking and devolatilizing an HDPE recyclate.

3. The composition of claim 1, wherein the modified HDPE recyclate has:
a) a density in the range of from 0.9480 g/cm³ to 0.9650 g/cm³; and
b) a high load melt index HLMI (I₂₁; 21.6 kg, 190° C.) in the range of from 80 dg/min. to 4,400 dg/min.

4. The composition of claim 3, wherein the modified HDPE recyclate further has:
a) a melt index MI (2.16 kg, 190° C.) in the range of from 2.0 dg/min. to 20 dg/min.;
b) a melt index ratio (HLMI/MI) in the range of from 30 to 50;
c) a complex viscosity (η*100) in the range of from 3,000 poise to 7,500 poise;
d) a melt elasticity (ER) in the range of from 0.75 to 1.50; or
e) a combination thereof.

5. The composition of claim 1, wherein the LLDPE has:
a) a density in the range of from 0.910 g/cm³ to 0.925 g/cm³; and
b) a high load melt index HLMI (I₂₁; 21.6 kg, 190° C.) in the range of from 8.0 dg/min. to 100 dg/min.

6. The composition of claim 5, wherein the LLDPE further has:
a) a melt index MI (I₂; 2.16 kg, 190° C.) in the range of from 0.80 dg/min. to 1.20 dg/min.;
b) a melt index ratio (HLMI/MI) in the range of from 10 to 35;
c) a complex viscosity (η*100) in the range of from 8,000 poise to 100,000 poise;
d) a melt elasticity (ER) in the range of from 0.10 to 0.90; or
e) a combination thereof.

7. The composition of claim 5, wherein the LLDPE is produced using a Ziegler-Natta catalyst, a metallocene catalyst, or a combination thereof.

8. The composition of claim 1, wherein the composition has:
a) a density in the range of from 0.949 g/cm³ to 0.954 g/cm³; and
b) a high load melt index HLMI (I₂₁; 21.6 kg, 190° C.) in the range of from 120 dg/min. to 210 dg/min.

9. The composition of claim 8, wherein the composition further has:
a) a melt index MI (I₂; 2.16 kg, 190° C.) in the range of from 2.0 dg/min. to 20 dg/min.;
b) a melt index ratio (HLMI/MI) in the range of from 30 to 50;
c) a complex viscosity (η*100) in the range of from 5,900 poise to 10,000 poise;
d) a melt elasticity (ER) in the range of from 0.6 to 1.0; or
e) a combination thereof.

10. The composition of claim 8, wherein the composition has physical properties comprising:
a) a notched Izod greater than or equal to 1.00 ft-lb/in (0.53 N-m/cm);
b) a NCTL at 30° C. greater than or equal to 10 hours;
c) a flexmod 1% secant modulus greater than or equal to 190 kpsi (1,310 MPa);
d) a container sidewall stiffness 1% secant modulus greater than or equal to 190 kpsi (1,310 MPa);
e) a container drop at-20° C. greater than or equal to 10 ft (3.0 m); or
f) a combination thereof.

11. A method for producing a composition useful injection molding using a high density polyethylene (HDPE) recyclate, the method comprising:
a) providing a HDPE recyclate having a MI (2.16 kg, 190° C.) in the range of from 0.1 dg/min. to 1.0 dg/min.;
b) subjecting the HDPE recyclate to visbreaking conditions to produce a modified HDPE recyclate having a MI (2.16 kg, 190° C.) in the range of from 2.0 dg/min. to 20 dg/min.; and
c) blending the modified HDPE recyclate with a linear low density polyethylene (LLDPE) to produce the composition.

12. The method of claim 11, wherein visbreaking conditions comprise thermal visbreaking or thermal visbreaking and devolatilization.

13. The method of claim 11, wherein the composition comprises from 50 wt. % to 95 wt. % of the modified HDPE recyclate, wherein weight percentage is based on the combined weight of the modified HDPE recyclate and the LLDPE.

14. The method of claim 11, wherein the modified HDPE recyclate has:
a) a density in the range of from 0.9480 g/cm³ to 0.9650 g/cm³; and
b) a high load melt index HLMI (21.6 kg, 190° C.) in the range of from 80 dg/min. to 4,400 dg/min.

15. The method of claim 14, wherein the modified HDPE recyclate further has:
a) a melt index MI (I₂; 2.16 kg, 190° C.) in the range of from 2.0 dg/min. to 20 dg/min.;
b) a melt index ratio (HLMI/MI) in the range of from 30 to 50;
c) a complex viscosity (η*100) in the range of from 3,000 poise to 7,500 poise;
d) a melt elasticity (ER) in the range of from 0.75 to 1.50; or
e) a combination thereof.

16. The method of claim 11, wherein the LLDPE has:
a) a density in the range of from 0.910 g/cm³ to 0.925 g/cm³; and
b) a high load melt index HLMI (I₂₁; 21.6 kg, 190° C.) in the range of from 8.0 dg/min. to 100 dg/min.

17. The method of claim 16, wherein the LLDPE further has:
a) a melt index MI (I₂; 2.16 kg, 190° C.) in the range of from 0.80 dg/min. to 1.20 dg/min.;
b) a melt index ratio (HLMI/MI) in the range of from 10 to 35;
c) a complex viscosity (η*100) in the range of from 8,000 poise to 100,000 poise;
d) a melt elasticity (ER) in the range of from 0.10 to 0.90; or
e) a combination thereof.

18. The method of claim 11, wherein the composition has:
a) a density in the range of from 0.949 g/cm³ to 0.954 g/cm³; and
b) a high load melt index HLMI (I₂₁; 21.6 kg, 190° C.) in the range of from 120 dg/min. to 210 dg/min.

19. The method of claim 18, wherein the composition further has:
a) a melt index MI (I₂; 2.16 kg, 190° C.) in the range of from 2.0 dg/min. to 20 dg/min.;
b) a melt index ratio (HLMI/MI) in the range of from 30 to 50;
c) a complex viscosity (η*100) in the range of from 5,900 poise to 10,000 poise;
d) a melt elasticity (ER) in the range of from 0.6 to 1.0; or
e) a combination thereof.

20. The method of claim 18, wherein the composition has physical properties comprising:
a) a notched Izod greater than or equal to 1.00 ft-lb/in (0.53 N-m/cm);
b) a NCTL at 30° C. greater than or equal to 10 hours;
c) a flexmod 1% secant modulus greater than or equal to 190 kpsi (1,310 MPa);
d) a container sidewall stiffness 1% secant modulus greater than or equal to 190 kpsi (1,310 MPa);
e) a container drop at −20° C. greater than or equal to 10 ft (3.0 m); or
f) a combination thereof.
